(19) United States
(12) Patent Application Publication
(10) Pub. No.: US 2026/0369816 A1
(43) Pub. Date: Nov. 19, 2026

(54) BATTERY PACK AND METHOD FOR MANUFACTURING THE SAME

(71) Applicant: SAMSUNG SDI CO., LTD., Yongin-si (KR)

(72) Inventors: Kyoungsoo KIM, Yongin-si (KR); Daehyeong YOO, Yongin-si (KR)

(21) Appl. No.: 19/393,828

(22) Filed: Nov. 19, 2025

(30) Foreign Application Priority Data
May 14, 2025 (KR) 10-2025-0062708

(51) Int. Cl. H01M 50/503; H01M 50/105; H01M 50/574

(52) U.S. Cl. CPC H01M 50/503; H01M 50/105; H01M 50/574

(57) ABSTRACT

A battery pack, including a housing, a protective circuit module in the housing, the protective circuit module including a circuit board having a connection tab, and a battery cell in the housing, the battery cell including an electrode tab coupled with the connection tab, wherein the connection tab and the electrode tab are coupled, resulting in a coupled tab, the coupled tab being bent at least once and on an upper side of the circuit board.

### CROSS-REFERENCE TO RELATED APPLICATION

The present application claims priority to and the benefit of Korean Application No. 10-2025-0062708, filed on May 14, 2025, in the Korean Intellectual Property Office, the entire disclosure of which is incorporated by reference herein.

### BACKGROUND

### 1. Field

The present disclosure relates to a battery pack and a method for manufacturing the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, electronic devices such as notebooks, netbooks, mobile computers, Ultra Mobile Personal Computers (UMPCs), and Portable Multimedia Players (PMPs) may use a battery pack formed by connecting a plurality of rechargeable secondary batteries, that is, battery cells, in series or in parallel as a mobile power source. Such a battery pack includes a protective circuit module (PCM) to protect the battery cells from overcharge, overdischarge, or overcurrent, and the battery cells and the protective circuit module may be embedded together in a housing.

The above information disclosed in this Background section is for enhancement of understanding of the background of the present disclosure, and therefore, it may contain information that does not constitute related (or prior) art.

### SUMMARY

Embodiments include a battery pack, including a housing, a protective circuit module in the housing, the protective circuit module including a circuit board having a connection tab, and a battery cell in the housing, the battery cell including an electrode tab coupled with the connection tab, wherein the connection tab and the electrode tab are coupled, resulting in a coupled tab, the coupled tab being bent at least once and on an upper side of the circuit board.

The coupled tab may include a coupled region where the connection tab and the electrode tab are coupled, and a non-coupled region where the connection tab and the electrode tab are not coupled.

The non-coupled region may be on the upper side of the circuit board, and the coupled region may be on an upper side of the non-coupled region.

A connection tab of the non-coupled region may be on the upper side of the circuit board, an electrode tab of the non-coupled region may be on an upper side of the connection tab of the non-coupled region, an electrode tab of the coupled region may be on an upper side of the electrode tab of the non-coupled region, and a connection tab of the coupled region may be on an upper side of the electrode tab of the coupled region.

The connection tab may have a length such that an end thereof protrudes to an outside of the housing, the connection tab being coupled to the circuit board.

The electrode tab may have a length corresponding to the connection tab, the electrode tab being on the connection tab.

The connection tab and the electrode tab may be welded together in an overlapping region outside the housing, resulting in a coupled region, the coupled region being bent to be on the upper side of the circuit board.

A width of the connection tab may be greater than a width of the electrode tab.

The connection tab may include a notch groove recessed inward from both ends in a width direction.

The notch groove may be on an upper side of an end of the circuit board.

The coupled tab may be bent around the notch groove.

The housing may include an avoidance groove recessed inward to not interfere with the connection tab when the coupled tab is not bent.

A width of the avoidance groove may be equal to or greater than a width of the connection tab.

The battery pack may further include a protective tape coupled to the circuit board, the protective tape covering the coupled tab.

The battery pack may further include an exterior tape coupled to the housing, the exterior tape covering the protective circuit module and the battery cell.

Embodiments include a method for manufacturing a battery pack, the method including disposing, in a housing, a protective circuit module including a circuit board, the protective circuit module having a connection tab protruding to an outside of the housing, disposing, in the housing, a battery cell with an electrode tab on the connection tab, coupling the connection tab and the electrode tab at an outside of the housing to form a coupled tab, and bending the coupled tab to be disposed on an upper side of the circuit board.

The connection tab and the electrode tab may be coupled by welding in an overlapping region outside the housing, and a resulting coupled region may be bent on the upper side of the circuit board.

A width of the connection tab may be greater than a width of the electrode tab.

The method for manufacturing a battery pack may further include coupling a protective tape to the circuit board to cover the coupled tab.

The method for manufacturing a battery pack may further include coupling an exterior tape to the housing while covering the protective circuit module and the battery cell.

### BRIEF DESCRIPTION OF DRAWINGS

Features will become apparent to those of ordinary skill in the art by describing in detail exemplary embodiments with reference to the attached drawings, in which:

FIG. 1 is a perspective view illustrating an example of a battery pack according to some embodiments of the present disclosure;

FIG. 2 is an enlarged view illustrating an example of region A of FIG. 1;

FIG. 3 is a partial cross-sectional view illustrating an example of a battery pack according to some embodiments of the present disclosure;

FIG. 4 is a side view illustrating an example of a state in which a connection tab and an electrode tab are welded in a battery pack according to some embodiments of the present disclosure;

FIG. 5 is a separated perspective view illustrating an example before a connection tab and an electrode tab are welded in a battery pack according to some embodiments of the present disclosure;

FIG. 6 is a perspective view illustrating an example before a connection tab and an electrode tab are welded in a battery pack according to some embodiments of the present disclosure;

FIG. 7 is a side view illustrating an example in which a connection tab and an electrode tab are welded in a battery pack according to some embodiments of the present disclosure;

FIG. 8 is a side view illustrating an example in which a connection tab and an electrode tab are bent after being welded in a battery pack according to some embodiments of the present disclosure;

FIG. 9 is a side view illustrating an example in which a connection tab is formed to be longer than an electrode tab in a battery pack according to some embodiments of the present disclosure;

FIG. 10 is a side view illustrating an example in which an end of a connection tab is welded after surrounding an electrode tab in a battery pack according to some embodiments of the present disclosure;

FIG. 11 is a perspective view illustrating an example in which a protective tape is coupled to a coupled tab in a battery pack according to some embodiments of the present disclosure;

FIG. 12 is a perspective view illustrating an example in which a notch groove is formed in a connection tab in a battery pack according to some embodiments of the present disclosure;

FIG. 13 is a perspective view illustrating an example in which a connection tab and an electrode tab are bent by a notch groove formed in the connection tab in a battery pack according to some embodiments of the present disclosure;

FIG. 14 is a perspective view illustrating an example in which an exterior tape is coupled to a housing in a battery pack according to some embodiments of the present disclosure; and

FIG. 15 is a flowchart illustrating an example of a method for manufacturing a battery pack according to some embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5 % or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

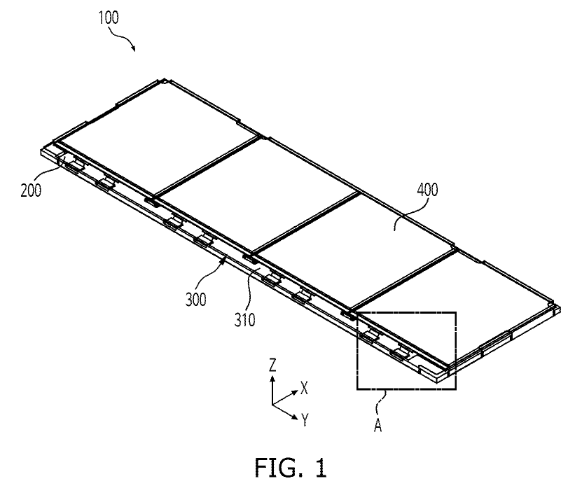

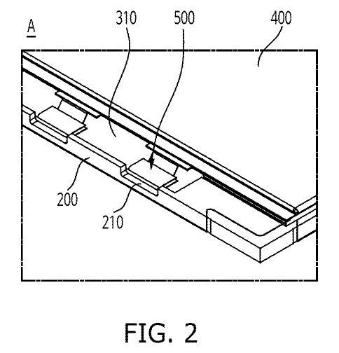

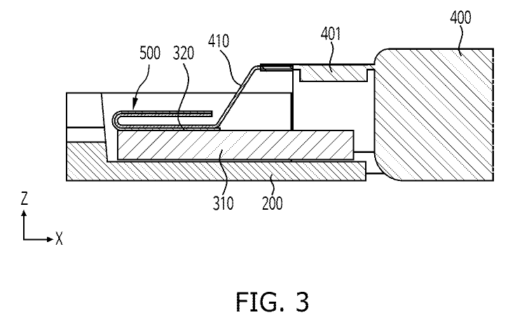

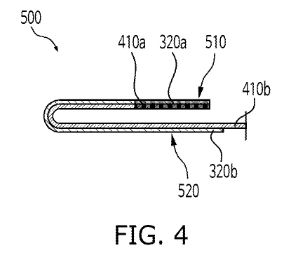

FIG. 1 is a perspective view illustrating an example of a battery pack according to some embodiments of the present disclosure, and FIG. 2 is an enlarged view illustrating an example of region A of FIG. 1. FIG. 3 is a partial cross-sectional view illustrating an example of a battery pack according to some embodiments of the present disclosure, and FIG. 4 is a side view illustrating an example of a state in which a connection tab and an electrode tab are welded in a battery pack according to some embodiments of the present disclosure.

Referring to FIGS. 1 - 4, a battery pack 100 according to some embodiments of the present disclosure may include a housing 200, a protective circuit module 300 including a circuit board 310 disposed in the housing 200 and provided with a connection tab 320, and a battery cell 400 disposed in the housing 200 and including an electrode tab 410 coupled with the connection tab 320. The electrode tab 410 provided in the battery cell 400 may be a positive electrode tab or a negative electrode tab.

The battery cell 400 may be a rechargeable secondary battery. The battery cell 400 may be configured such that an electrode assembly and an electrolyte are accommodated in a case. The electrode assembly may be manufactured by stacking a positive electrode plate, a separator, and a negative electrode plate, or by winding them in a jelly-roll form. In some embodiments, the battery cell 400 may be a pouch-type secondary battery. When the battery cell 400 is a pouch-type secondary battery, a negative electrode tab electrically connected to a negative electrode plate and a positive electrode tab electrically connected to a positive electrode plate may be provided to protrude to an outside of the case. Of course, the type and form of the battery cell 400 may vary, and a cylindrical or prismatic battery cell may also be applied.

A plurality of the battery cells 400 may be provided and arranged in parallel along a second direction Y in the housing 200. Of course, the battery cells 400 may be housed in the housing 200 in a state of being stacked on each other.

The protective circuit module 300 may be a configuration that is electrically connected to an external power supply device and controls charging and discharging of the battery cell 400. The protective circuit module 300 may include a circuit board 310 (plate shaped) on which a plurality of wiring patterns are formed, and a connection tab 320 electrically connected to the wiring patterns formed on the circuit board 310.

The circuit board 310 may include a plurality of protective elements electrically connected through the wiring patterns. The connection tab 320 may be coupled to and electrically connected with the electrode tab 410 of the battery cell 400. The connection tab 320 is electrically connected to the wiring pattern provided on the circuit board 310, so that the electrode tab 410 may be electrically connected to the protective circuit module 300.

Referring to FIG. 3, the battery cell 400 may include a terrace portion 401 that supports the electrode tab 410 to extend to the outside. The terrace portion 401 may be formed to protrude from the battery cell 400 in a first direction X. The terrace portion 401 may be disposed to be spaced apart from the circuit board 310 by a predetermined distance in a third direction Z. Accordingly, the electrode tab 410 protruding from the terrace portion 401 may be coupled to the connection tab 320 while being bent downward in the third direction Z. As the terrace portion 401 and the circuit board 310 are disposed spaced apart by a predetermined distance, it is possible to prevent the electrode tab 410 from coming into contact with a plurality of protective elements and wiring patterns disposed on the circuit board 310.

When a plurality of the battery cell 400 are accommodated in the housing 200, the circuit board 310 may be disposed in the housing 200 along a second direction Y in which the plurality of battery cells 400 are disposed. And, a plurality of the connection tabs 320 may be provided on the circuit board 310 to be respectively coupled with the electrode tabs 410 provided in the plurality of battery cells 400. The plurality of connection tabs 320 may be electrically connected in series or in parallel between the plurality of battery cells 400 by wiring patterns provided on the circuit board 310.

The connection tab 320 provided on the circuit board 310 and the electrode tab 410 of the battery cell 400 are coupled to each other by welding to form a coupled tab 500, and the coupled tab 500 may be bent at least once to be disposed on an upper side of the circuit board 310. Here, the upper side of the circuit board 310 may mean an upper side based on a third direction Z, which is a direction perpendicular to a first direction X in which the circuit board 310 and the battery cell 400 are disposed and a second direction Y in which the plurality of battery cells 400 are disposed, with reference to the drawing. Hereinafter, the upper side may mean an upper side based on the third direction Z.

Referring to FIG. 4, the coupled tab 500 may include a coupled region 510 where the connection tab 320 and the electrode tab 410 are coupled, and a non-coupled region 520 where the connection tab 320 and the electrode tab 410 are not coupled. Ends of the connection tab 320 and the electrode tab 410 are coupled to each other by welding to form the coupled region 510, and a remaining region where the connection tab 320 and the electrode tab 410 overlap may form the non-coupled region 520.

In some embodiments, end regions of the connection tab 320 and the electrode tab 410 may be bent after being coupled to each other by welding, so that the coupled region 510 is disposed on an upper side of the non-coupled region 520. The non-coupled region 520 may be disposed on an upper side of the circuit board 310, and the coupled region 510 may be disposed on an upper side of the non-coupled region 520. A connection tab 320b of the non-coupled region 520 may be disposed on the upper side of the circuit board 310, an electrode tab 410b of the non-coupled region 520 may be disposed on an upper side of the connection tab 320b of the non-coupled region 520, an electrode tab 410a of the coupled region 510 may be disposed on an upper side of the electrode tab 410b of the non-coupled region 520, and a connection tab 320a of the coupled region 510 may be disposed on an upper side of the electrode tab 410a of the coupled region 510.

A bent portion of the coupled tab 500 may be disposed inside the housing 200. The coupled tab 500 may be bent so as not to be exposed to an outside of the housing 200.

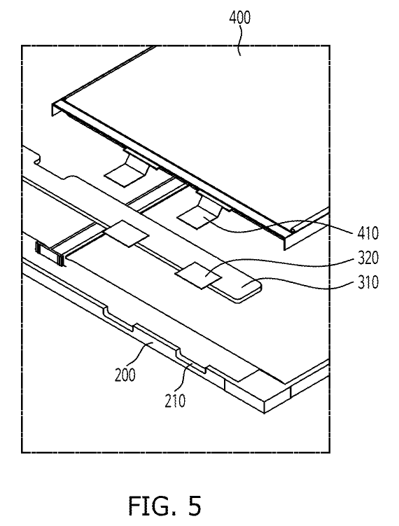

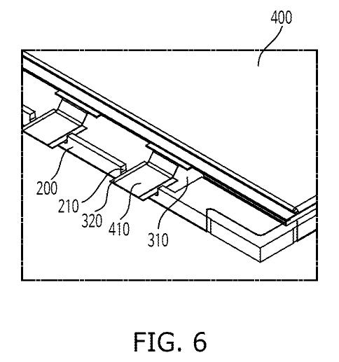

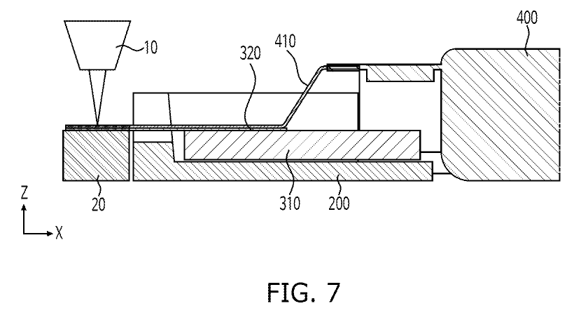

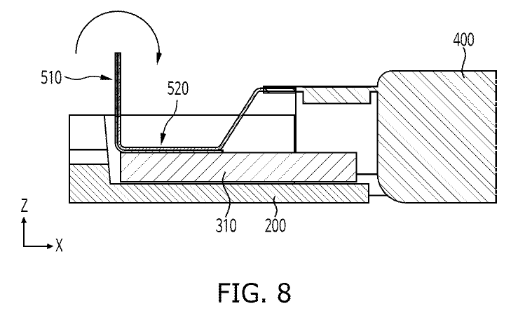

FIG. 5 is a separated perspective view illustrating an example before a connection tab and an electrode tab are welded in a battery pack according to some embodiments of the present disclosure, and FIG. 6 is a perspective view illustrating an example before a connection tab and an electrode tab are welded in a battery pack according to some embodiments of the present disclosure. FIG. 7 is a side view illustrating an example in which a connection tab and an electrode tab are welded in a battery pack according to some embodiments of the present disclosure, and FIG. 8 is a side view illustrating an example in which a connection tab and an electrode tab are bent after being welded in a battery pack according to some embodiments of the present disclosure.

Referring to FIGS. 5 - 8, the connection tab 320 is formed to a length such that an end thereof protrudes to an outside of the housing 200 in a state of being coupled to the circuit board 310, and the electrode tab 410 may be formed to a length corresponding to the connection tab 320 in a state of being disposed on the connection tab 320. In a state where the circuit board 310 and the battery cell 400 are disposed in the housing 200, the lengths of the connection tab 320 and the electrode tab 410 protruding to the outside of the housing 200 may be the same or similar.

The housing 200 may include an avoidance groove 210 that is recessed inward so as not to interfere with the connection tab 320 when the coupled tab 500 is not bent. The avoidance groove 210 may be formed in the housing 200 to prevent the connection tab 320 and the electrode tab 410 from being bent due to interference with an end of the housing 200 when the connection tab 320 and the electrode tab 410 protrude to the outside of the housing 200. A width of the avoidance groove 210 may be formed to be equal to or greater than a width of the connection tab 320 so that the connection tab 320 can be inserted into the avoidance groove 210.

The connection tab 320 and the electrode tab 410 may be joined by welding in an overlapping region outside the housing 200. In some embodiments, the connection tab 320 and the electrode tab 410 protruding to the outside of the housing 200 are disposed on a support block 20 in an overlapping state, and a laser is irradiated to the connection tab 320 and the electrode tab 410 through a laser device 10 disposed on an upper side of the connection tab 320 and the electrode tab 410, so that the connection tab 320 and the electrode tab 410 may be laser-welded. Laser welding may also be performed while the connection tab 320 and the electrode tab 410 are pressed by a pressing jig.

The connection tab 320 and the electrode tab 410 can be welded outside the housing 200, which is spaced a certain distance from the circuit board 310 in a first direction X, thereby preventing the circuit board 310 from being damaged by welding heat generated during laser welding.

When the connection tab 320 and the electrode tab 410 are coupled by welding, the coupled region 510 may be bent to be disposed on an upper side of the circuit board 310. The coupled tab 500 may be bent such that a point where the coupled tab 500 is bent is located inside the housing 200.

A width of the connection tab 320 may be formed to be larger than a width of the electrode tab 410. As the width of the connection tab 320 is formed larger than the width of the electrode tab 410, when the coupled tab 500 is bent, the electrode tab 410 is disposed inside the connection tab 320, so that the electrode tab 410 may be protected.

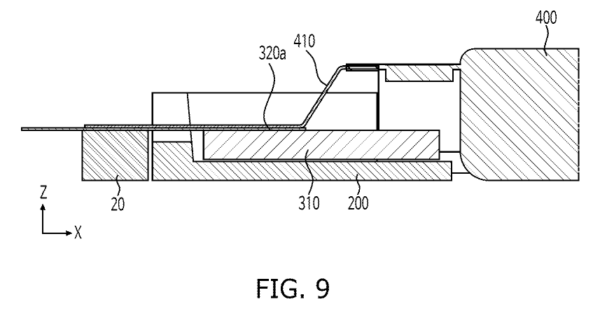

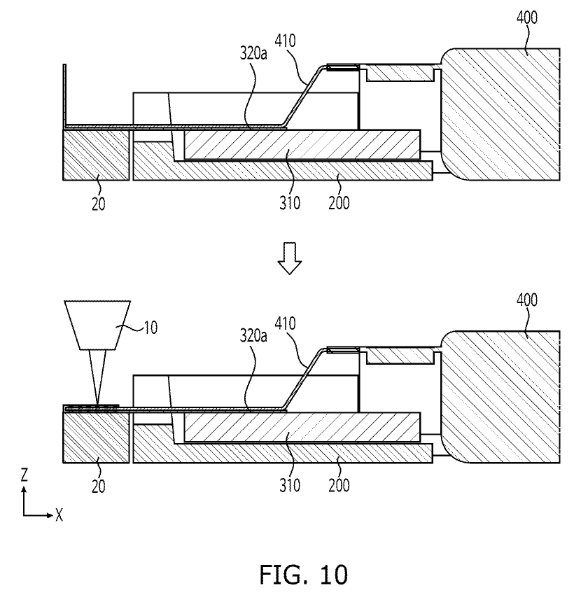

FIG. 9 is a side view illustrating an example in which a connection tab is formed to be longer than an electrode tab in a battery pack according to some embodiments of the present disclosure, and FIG. 10 is a side view illustrating an example in which an end of a connection tab is welded after surrounding an electrode tab in a battery pack according to some embodiments of the present disclosure.

Referring to FIG. 9, a connection tab 320a may be formed to have a longer length than the electrode tab 410. In some embodiments, the connection tab 320a may be formed to be longer than the electrode tab 410 along a first direction X, and may be disposed to protrude to an outside of the support block 20.

Referring to FIG. 10, a portion of the connection tab 320a that is formed longer than the electrode tab 410 may be bent and disposed on an upper side of the electrode tab 410. That is, the connection tab 320a may be disposed in a form that surrounds an end region of the electrode tab 410. In this state, a laser may be irradiated to the connection tab 320a through the laser device 10 to laser-weld the connection tab 320a and the electrode tab 410.

In some embodiments, when materials of the connection tab 320a and the electrode tab 410 are different, they may be welded in the same manner as described above. For example, the connection tab 320a may be formed of nickel (Ni) or a nickel alloy foil, and the electrode tab 410 may be formed of aluminum (Al) or an aluminum alloy foil. Since nickel has a much higher melting point than aluminum, welding may not be easy due to melting imbalance. Therefore, the nickel foil is disposed in a form that surrounds the aluminum foil, and a laser beam is irradiated to the nickel foil, so that the intermediately disposed aluminum foil is melted and may be coupled with the nickel foils disposed on an upper side and a lower side of the aluminum foil.

When the materials of the connection tab 320a and the electrode tab 410 are the same or similar, they may be welded in this manner to improve the coupling strength between the connection tab 320a and the electrode tab 410. When the connection tab 320a and the electrode tab 410 are coupled by welding, the coupled region may be bent to be disposed on an upper side of the circuit board 310.

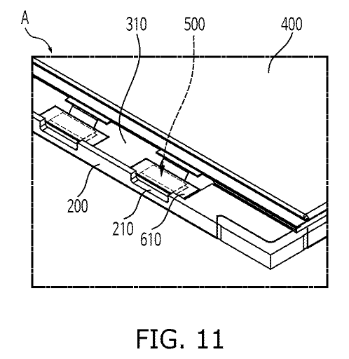

FIG. 11 is a perspective view illustrating an example in which a protective tape is coupled to a coupled tab in a battery pack according to some embodiments of the present disclosure.

Referring to FIG. 11, a battery pack according to some embodiments of the present disclosure may further include a protective tape 610 that covers the coupled tab 500 and is coupled to the circuit board 310. After ends of a connection tab and an electrode tab are coupled outside the housing 200 to form the coupled tab 500, the coupled tab 500 is bent and disposed on an upper side of the circuit board 310, and the protective tape 610 is attached to an upper side of the coupled tab 500 that is bent to prevent the coupled tab 500 that is bent from being deformed.

A width of the protective tape 610 may be formed in a size that can cover the entirety of coupled tab 500 in a bent state. A length of the protective tape 610 may be formed to a length such that both sides are attached to the circuit board 310 in a state of being attached to the coupled tab 500 that is bent.

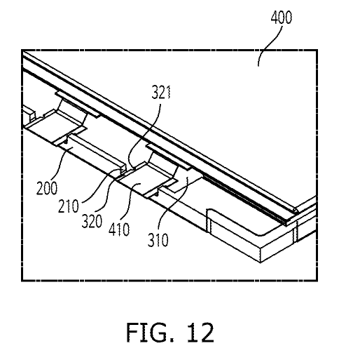

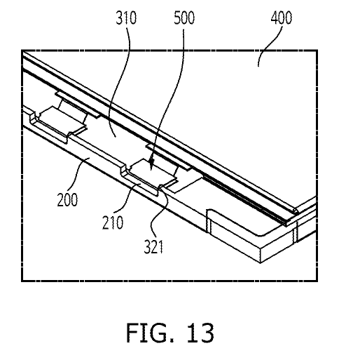

FIG. 12 is a perspective view illustrating an example in which a notch groove is formed in a connection tab in a battery pack according to some embodiments of the present disclosure, and FIG. 13 is a perspective view illustrating an example in which a connection tab and an electrode tab are bent by a notch groove formed in the connection tab in a battery pack according to some embodiments of the present disclosure.

Referring to FIGS. 12 and 13, the connection tab 320 may include a notch groove 321 that is recessed inward from both ends in a width direction, which is a direction perpendicular to a direction protruding to an outside of the housing 200.

After the connection tab 320 and the electrode tab 410 are coupled outside the housing 200 to form the coupled tab 500, the coupled tab 500 may be bent around the notch groove 321 and disposed on an upper side of the circuit board 310. A position where the coupled tab 500 is bent may be guided by the notch groove 321.

In some embodiments, the notch groove 321 may be disposed on an upper side of an end of the circuit board 310. Accordingly, a bent portion formed by bending the coupled tab 500 may be disposed at the end of the circuit board 310. Of course, the position where the notch groove 321 may be formed at a position where the bent portion formed after the coupled tab 500 is bent can be disposed inside the housing 200.

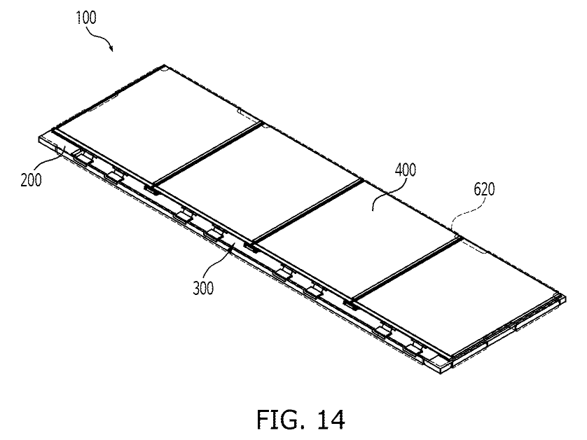

FIG. 14 is a perspective view illustrating an example in which an exterior tape is coupled to a housing in a battery pack according to some embodiments of the present disclosure.

Referring to FIG. 14, a battery pack according to some embodiments of the present disclosure may further include an exterior tape 620 coupled to the housing 200 while covering the protective circuit module 300 and the battery cell 400. After an electrode tab of the battery cell 400 and a connection tab of the protective circuit module 300 are coupled and bent to an inside of the housing 200, the exterior tape 620 may be coupled to the housing 200. In some embodiments, the exterior tape 620 may be coupled to the housing 200 so that a region where the connection tab and the electrode tab are coupled is not exposed to the outside.

The exterior tape 620 being coupled to cover the protective circuit module 300 and the battery cell 400, and a separate case may be configured to be coupled to the housing 200 while covering the protective circuit module 300 and the battery cell 400.

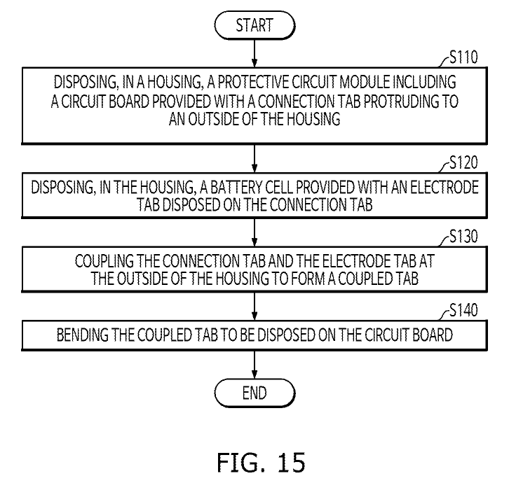

FIG. 15 is a flowchart illustrating an example of a method for manufacturing a battery pack according to some embodiments of the present disclosure.

Referring to FIGS. 5 - 8 and 15, a method for manufacturing a battery pack according to some embodiments of the present disclosure may include a step S110 of disposing, in a housing 200, a protective circuit module 300 including a circuit board 310 provided with a connection tab 320 protruding to an outside of the housing 200, a step S120 of disposing, in the housing 200m a battery cell 400 provided with an electrode tab 410 disposed on the connection tab 320, a step S130 of coupling the connection tab 320 and the electrode tab 410 at the outside of the housing 200 to form a coupled tab 500, and a step S140 of bending the coupled tab 500 to be disposed on an upper side of the circuit board 310.

The connection tab 320 is formed to a length such that an end thereof protrudes to the outside of the housing 200 in a state of being coupled to the circuit board 310, and the electrode tab 410 may be formed to a length corresponding to the connection tab 320 in a state of being disposed on the connection tab 320. After disposing the circuit board 310 in the housing 200 (S110) and then disposing the battery cell 400 in the housing 200 (S120), the electrode tab 410 is disposed on the connection tab 320 to overlap each other, and ends of the connection tab 320 and the electrode tab 410 may be disposed outside the housing 200.

The connection tab 320 and the electrode tab 410 may be coupled S130 by welding in an overlapping region outside the housing 200. In some embodiments, the connection tab 320 and the electrode tab 410 protruding to the outside of the housing 200 may be laser-welded in an overlapping state.

When the connection tab 320 and the electrode tab 410 are coupled S130 by welding, the coupled region 510 may be bent S140 to be disposed on an upper side of the circuit board 310. The coupled tab 500 may be bent such that a point where the coupled tab 500 is bent is located inside the housing 200.

A width of the connection tab 320 may be formed to be larger than a width of the electrode tab 410. As the width of the connection tab 320 is formed larger than the width of the electrode tab 410, when the coupled tab 500 is bent, the electrode tab 410 is disposed inside the connection tab 320, so that the electrode tab 410 may be protected.

Referring to FIGS. 12 and 13, the connection tab 320 may include a notch groove 321 that is recessed inward from both ends in a width direction, which is a direction perpendicular to a direction protruding to an outside of the housing 200. Accordingly, the step S140 of bending the coupled tab 500 to be disposed on the circuit board 310 may cause the coupled tab 500 to be disposed on the upper side of the circuit board 310 by bending the coupled tab 500 around the notch groove 321. A position where the coupled tab 500 is bent may be guided by the notch groove 321.

Referring to FIG. 11, a method for manufacturing a battery pack according to some embodiments of the present disclosure may further include a step of coupling a protective tape 610 to the circuit board 310 to cover the coupled tab 500. After ends of the connection tab and the electrode tab are coupled outside the housing 200 to form the coupled tab 500, the coupled tab 500 is bent and disposed on an upper side of the circuit board 310, and the protective tape 610 is attached to an upper side of the coupled tab 500 that is bent to prevent the coupled tab 500 that is bent from being deformed.

Referring to FIG. 12, a method for manufacturing a battery pack according to some embodiments of the present disclosure may further include a step of coupling an exterior tape 620 to the housing 200 while covering the protective circuit module 300 and the battery cell 400. After an electrode tab of the battery cell 400 and a connection tab of the protective circuit module 300 are coupled and bent to an inside of the housing 200, the exterior tape 620 may be coupled to the housing 200. In some embodiments, the exterior tape 620 may be coupled to the housing 200 so that a region where the connection tab and the electrode tab are coupled is not exposed to the outside.

The circuit board of the protective circuit module is provided with a connection tab to which an electrode tab of the battery cell is welded, and the connection tab and the electrode tab may be joined by laser welding. However, as the connection tab and the electrode tab are laser welded on the circuit board, a problem may occur in that the circuit board is damaged by welding heat.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of skill in the art that various changes in form and details may be made without departing from the spirit and scope of the present invention as set forth in the following claims.

What is claimed is:

1. A battery pack, comprising:
a housing;
a protective circuit module in the housing, the protective circuit module including a circuit board having a connection tab; and
a battery cell in the housing, the battery cell including an electrode tab coupled with the connection tab,
wherein the connection tab and the electrode tab are coupled, resulting in a coupled tab, the coupled tab being bent at least once and on an upper side of the circuit board.

2. The battery pack as claimed in claim 1, wherein the coupled tab comprises:
a coupled region where the connection tab and the electrode tab are coupled; and
a non-coupled region where the connection tab and the electrode tab are not coupled.

3. The battery pack as claimed in claim 2, wherein the non-coupled region is on the upper side of the circuit board, and the coupled region is on an upper side of the non-coupled region.

4. The battery pack as claimed in claim 3, wherein:
a connection tab of the non-coupled region is on the upper side of the circuit board,
an electrode tab of the non-coupled region is on an upper side of the connection tab of the non-coupled region,
an electrode tab of the coupled region is on an upper side of the electrode tab of the non-coupled region, and
a connection tab of the coupled region is on an upper side of the electrode tab of the coupled region.

5. The battery pack as claimed in claim 1, wherein the connection tab has a length such that an end thereof protrudes to an outside of the housing, the connection tab being coupled to the circuit board.

6. The battery pack as claimed in claim 5, wherein the electrode tab has a length corresponding to the connection tab, the electrode tab being on the connection tab.

7. The battery pack as claimed in claim 5, wherein the connection tab and the electrode tab are welded together in an overlapping region outside the housing, resulting in a coupled region, the coupled region being bent to be on the upper side of the circuit board.

8. The battery pack as claimed in claim 1, wherein a width of the connection tab is greater than a width of the electrode tab.

9. The battery pack as claimed in claim 1, wherein the connection tab comprises a notch groove recessed inward from both ends in a width direction.

10. The battery pack as claimed in claim 9, wherein the notch groove is on an upper side of an end of the circuit board.

11. The battery pack as claimed in claim 9, wherein the coupled tab is bent around the notch groove.

12. The battery pack as claimed in claim 1, wherein the housing comprises an avoidance groove recessed inward to not interfere with the connection tab when the coupled tab is not bent.

13. The battery pack as claimed in claim 12, wherein a width of the avoidance groove is equal to or greater than a width of the connection tab.

14. The battery pack as claimed in claim 1, further comprising a protective tape coupled to the circuit board, the protective tape covering the coupled tab.

15. The battery pack as claimed in claim 1, further comprising an exterior tape coupled to the housing, the exterior tape covering the protective circuit module and the battery cell.

16. A method for manufacturing a battery pack, the method comprising:
disposing, in a housing, a protective circuit module comprising a circuit board, the protective circuit module having a connection tab protruding to an outside of the housing;
disposing, in the housing, a battery cell with an electrode tab on the connection tab;
coupling the connection tab and the electrode tab at an outside of the housing to form a coupled tab; and
bending the coupled tab to be disposed on an upper side of the circuit board.

17. The method for manufacturing a battery pack as claimed in claim 16, wherein the connection tab and the electrode tab are coupled by welding in an overlapping region outside the housing, and a resulting coupled region is bent on the upper side of the circuit board.

18. The method for manufacturing a battery pack as claimed in claim 16, wherein a width of the connection tab is greater than a width of the electrode tab.

19. The method for manufacturing a battery pack as claimed in claim 16, further comprising coupling a protective tape to the circuit board to cover the coupled tab.

20. The method for manufacturing a battery pack as claimed in claim 16, further comprising coupling an exterior tape to the housing while covering the protective circuit module and the battery cell.
